(19) United States
(12) Patent Application Publication
(10) Pub. No.: US 2007/0161444 A1
(43) Pub. Date: Jul. 12, 2007

(54) Traction mechanism drive, in particular for an internal combustion engine

(75) Inventor: Bernd Hartmann, Weisendorf (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/482,565

(22) Filed: Jul. 7, 2006

Related U.S. Application Data
(60) Provisional application No. 60/697,926, filed on Jul. 8, 2005.

(51) Int. Cl. F16H 7/12; F16H 7/08

(52) U.S. Cl. 474/133; 474/101; 474/117

(57) ABSTRACT

Traction mechanism drive, in particular for an internal combustion engine, having a wraparound means, having a tensioning device which acts on the wraparound means, having at least one driving wheel and at least one driven wheel, at least one of which is non-circular and/or is mounted eccentrically, wherein the tensioning device is embodied as a latching tensioner (7, 21) having one part (8) which is fastened to the engine and one part (9) which is moveable with respect thereto, said parts being latched to one another, wherein, when the tension of the wraparound means decreases, the moveable part (9) is moved in the direction of the wraparound means under the action of a spring element, and a movement in the opposite direction is blocked.

### FIELD OF THE INVENTION

The invention relates to a traction mechanism drive, in particular for an internal combustion engine, having a wraparound means, having a tensioning device which acts on the wraparound means, having at least one driving wheel and at least one driven wheel, at least one of which is non-circular and/or is mounted eccentrically.

### BACKGROUND OF THE INVENTION

Control drives of internal combustion engines conventionally have a crankshaft driving wheel, one, two or more camshaft driving wheels, and a wraparound means which is preferably embodied as a chain or a belt. In addition or alternatively, further wheel-driven traction mechanism drive components can be present, said components comprising units such as a water pump, a generator, an air conditioning compressor etc. Traction mechanism drives are subject to vibrational changes as a result of torque fluctuations or angular speed changes, which vibrational changes can lead to audible noise in resonant ranges. Associated with this are increased frictional forces which can adversely affect the service life and the efficiency of the wraparound drive.

It has already been proposed in DE 195 20 508 A1 to provide a means which imparts an additional nonuniformity to the wraparound drive. Said nonuniformity can be generated by means of a wheel which is non-circular and/or is mounted eccentrically. Said artificially generated nonuniformities are intended to counteract the vibrational changes which are produced by combustion processes and valve movements. The required belt tension is to be generated using a belt tensioner having a tensioning wheel. Conventional belt tensioners, in particular hydraulic tensioning elements, are however comparatively expensive, so that it has not hitherto been possible for wraparound drives of such type to have become established in practice.

### SUMMARY OF THE INVENTION

The invention is therefore based on the problem of specifying a traction mechanism drive which can be produced more cost-effectively and ensures a long service life.

According to the invention, in order to solve said problem, it is provided, in a traction mechanism drive of the type mentioned in the introduction, that the tensioning device is embodied as a latching tensioner having one part which is fastened to the engine and one part which is moveable with respect thereto, said parts being latched to one another, wherein, when the tension of the wraparound means decreases, the moveable part is moved in the direction of the wraparound means under the action of a spring element, and a movement in the opposite direction is blocked.

The invention is based on the realization that instead of a hydraulic tensioning system, a simply-designed and cost-effective latching tensioner can be used, said latching tensioner being integrated into the traction mechanism drive. The traction mechanism drive according to the invention comprises at least one non-circular and/or eccentrically mounted wheel, and a latching tensioner is additionally used in order to ensure an approximately constant tension of the wraparound means throughout the entire service life of the traction mechanism drive. The wraparound means is preferably embodied as a control chain or a control belt. Said wraparound means tend to stretch with continued use, resulting in several problems, inter alia, reliable guidance on the wheels or pulleys is no longer ensured with a stretched wraparound means. In addition, the service life of the wraparound means decreases if it is not operated with the intended tension. During operation, the moveable part of the latching tensioner, on which a wheel is preferably mounted as a tensioning roller, bears against the wraparound means, so that there is force equilibrium between the force of the spring element, which presses the moveable part against the wraparound means, and the reaction force on the wraparound means. If the tension in the wraparound means decreases, the force of the spring element is greater than the counteracting force exerted by the wraparound means on the moveable part, so that the moveable part is moved toward the wraparound means. As a result, the wheel which is connected to the moveable part, and a unit which is, if appropriate, coupled to the wheel, is pressed into the traction mechanism drive. It is basically irrelevant whether the latching tensioner and the wheel which is connected thereto are arranged outside or within the wraparound means, however, it is preferred in most cases that the latching tensioner presses the wheel into the traction mechanism drive from outside. The latching tensioner is designed such that it only acts in one direction; accordingly, the moveable part can be moved away from the stationary part toward the wraparound means, while a movement of the latching tensioner in the opposite direction, that is to say in the direction of the stationary part, is however blocked. This design leads to the moveable part of the latching tensioner being moved toward the wraparound means as the wraparound means is progressively stretched.

In a further embodiment of the invention, it can be provided that the wheel which is connected to the latching tensioner is arranged on a rotatably or pivotably mounted bracket device and can move with the latter. Such a design has the advantage that the fastening and mounting points can be selected according to the respective installation conditions. The bracket device expediently has a first mounting point, by means of which it is rotatably or pivotably mounted on the engine, and a second mounting point, by means of which it is connected to the latching tensioner. It is also conceivable that the bracket device is not mounted directly on the engine or engine block, but rather on a vehicle component which is connected thereto, for example on a unit or on the vehicle body, though it is preferred to attach the bracket device to the engine block. For a bracket device which has two mounting points, the latter can be arranged approximately opposite one another on both sides of the wheel.

Particularly reliable functioning of the traction mechanism drive according to the invention can be obtained if the moveable part of the latching tensioner comprises catches in which a spring-loaded latching element of the part which is fastened to the engine engages. If the tension in the traction mechanism drive decreases, the moveable part, which has catches, of the latching tensioner is displaced toward the wraparound means, so that the spring-loaded latching element of the stationary part engages in adjacent or other catches. The part which is fastened to the engine particularly advantageously has a blocking device which blocks a movement in the opposite direction. Said blocking device functions similarly to a ratchet, since it permits a movement of the moveable part away from the stationary part, and blocks a movement in the opposite direction.

The wraparound means of the traction mechanism drive according to the invention can be an elastic belt having a high degree of, although a conventional belt, which is more cost-effective, can also be used.

### BRIEF DESCRIPTION OF THE DRAWINGS

Further advantages and details of the invention can be gathered from the following description of exemplary embodiments with reference to the figures. The figures are schematic illustrations, in which:

FIG. 1 shows a first exemplary embodiment of the invention having a latching tensioner which has a tensioning roller; and

FIG. 2 shows a second exemplary embodiment of the invention, in which the latching tensioner is fastened to a rotatably mounted bracket device.

### DETAILED DESCRIPTION OF THE DRAWINGS

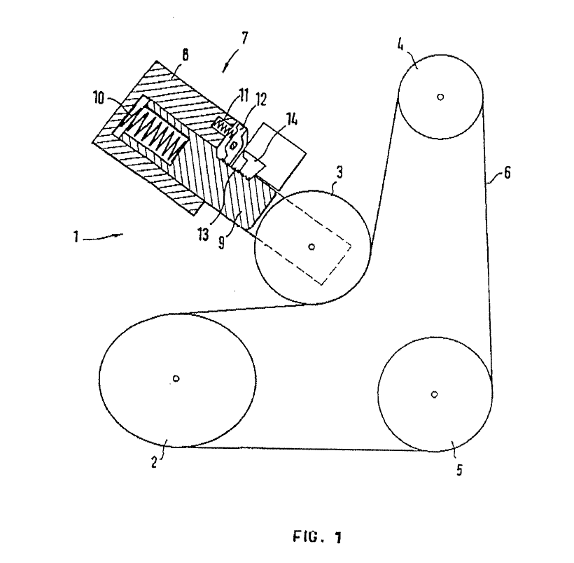

FIG. 1 shows a first exemplary embodiment having a latching tensioner which has a tensioning roller.

The traction mechanism drive 1, as illustrated in FIG. 1, for an internal combustion engine consists substantially of a driving wheel 2, which is connected to the crankshaft of the engine, and driven wheels 3, 4, 5, and a belt 6 which is guided around the wheels 2, 3, 4, 5. In the illustrated exemplary embodiment, the wheel 3 serves as a tensioning roller for a latching tensioner 7, the wheel 4 is connected to the shaft of a generator, and the wheel 5 drives an air conditioning compressor. In other embodiments, further wheels for other units can also be present, for example camshaft driving wheels.

As can be seen in FIG. 1, the crankshaft wheel 2 is non-circular, having approximately the shape of an ellipse. A nonuniformity is imparted to the traction mechanism drive 1 by the non-circular wheel 2, said nonuniformity being superposed on and influencing the nonuniformity which is present on account of the system. Every internal combustion engine has a critical speed range in which vibrations and, if appropriate, even resonance can occur. The critical resonance range and/or speed range can be displaced into a nondisruptive range by means of the nonuniformity imparted by the non-circular driving wheel 2, and if appropriate, the vibrations which occur can also be reduced by means of superposition.

The latching tensioner 7 consists of a stationary part, which is attached to the engine block, and a part 9 which is movable with respect thereto and to which the driven wheel 3, which serves as a tensioning roller, is rotatably fastened.

The latching tensioner 7 is adjusted such that a certain adjustable tension of the belt 6 is generated by means of the wheel 3. A pressure spring 10 is arranged in the interior of the moveable part 9, said pressure spring 10 being supported on the stationary part 8 and acting on the moveable part 9 at all times. During operation of the traction mechanism drive 1, there is force equilibrium between the force generated by the pressure spring 10 and the equal, counteracting reaction force which is exerted by the belt 6 on the wheel 3. If the belt 6 is stretched, the force exerted by the pressure spring 10 is greater than the counteracting force of the belt 6, so that the moveable part 9 is moved toward the belt 6. During said relative movement between the moveable part 9 and the stationary part 8 of the latching tensioner 7, a latching element 12, which is acted on by a spring 11, is displaced by one or more catches 13 which are formed on the moveable part 9. The latching tensioner additionally comprises a blocking device 14 which acts as a ratchet and prevents the moveable part 9 from being displaced back in the direction of the stationary part 8. The moveable part 9 can therefore only be moved away from the stationary part 8 in the direction of the belt, but cannot subsequently return to its original position.

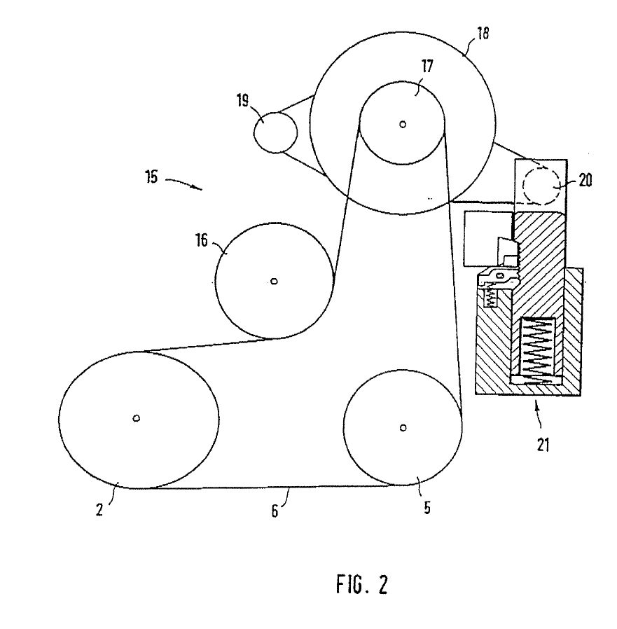

FIG. 2 shows a second exemplary embodiment, in which the latching tensioner is fastened to a rotatably mounted bracket device.

The traction mechanism drive 15 shown in FIG. 2 comprises, in accordance or in the same way as with the first exemplary embodiment, a belt 6 which is driven by a crankshaft wheel 2. Driven wheels 5, 16 of an air conditioning compressor and of a water pump are also present. The driven wheel 17 of a generator is rotatably mounted on a bracket device 18. The bracket device 18 has a first mounting point 19 on the engine block, at which the bracket device 18 is rotatably mounted. The bracket device 18 also comprises a second mounting point 20, at which it is connected to a latching tensioner 21. The design and function of the latching tensioner 21 correspond to those of the latching tensioner 7 of the first exemplary embodiment. The latching tensioner 21 comprises a stationary part, which is attached to the engine block, and a part which is moveable with respect thereto and on which is situated the mounting point 20.

When the tension of the belt 6 decreases, the moveable part of the latching tensioner 21 is moved away from the stationary part of the latching tensioner, wherein the moving mounting point 20 performs a counterclockwise rotational movement about the mounting point 19. As a result, the driven wheel 17 is displaced in such a way that the tension of the belt is increased.

The belt 6 can be a so-called elastic belt which is distinguished by a particularly a high degree of elasticity. Alternatively, a conventional belt can also be used, which is particularly cost-effective.

### LIST OF REFERENCE SYMBOLS

1 Traction mechanism drive
2 Driving wheel
3 Driven wheels
4 Driven wheels
5 Driven wheels
6 Belt
7 Latching tensioner
8 Stationary part
9 Moveable part
10 Pressure spring
11 Spring
12 Latching element
13 Catches
14 Blocking device
15 Traction mechanism drive
16 Driven wheel
17 Driven wheel
18 Bracket device
19 Mounting point
20 Mounting point
21 Latching tensioner

1. Traction mechanism drive, for an internal combustion engine, comprising a wraparound means, a tensioning device which acts on the wraparound means, having at least one driving wheel and at least one driven wheel, at least one of which is non-circular and/or is mounted eccentrically, wherein the tensioning device is embodied as a latching tensioner having one part which is fastened to the engine and one part which is moveable with respect thereto, said parts being latched to one another, wherein, when the tension of the wraparound means decreases, the moveable part is moved in the direction of the wraparound means under the action of a spring element, and a movement in the opposite direction is blocked.

2. Traction mechanism drive according to claim 1, wherein one of the wheels, coupled to a unit, is arranged on the moveable part of the latching tensioner.

3. Traction mechanism drive according to claim 2, wherein the wheel which is connected to the latching tensioner is arranged on a rotatably or pivotably mounted bracket device and can move with the latter.

4. Traction mechanism drive according to claim 3, wherein the bracket device has a first mounting point, by means of which it is rotatably or pivotably mounted on the engine, and a second mounting point, by means of which it is connected to the latching tensioner.

5. Traction mechanism drive according to claim 1 wherein the moveable part of the latching tensioner comprises catches into which a spring-loaded latching element of the stationary part engages.

6. Traction mechanism drive according to claim 5, wherein the stationary part has a blocking device which blocks a movement in the opposite direction.

7. Traction mechanism drive according to claim 1 wherein the wraparound means is an elastic belt having a high degree of elasticity.
